(19) United States
(12) Patent Application Publication
(10) Pub. No.: US 2006/0102273 A1
(43) Pub. Date: May 18, 2006

(54) Method for preserving a perishable product

(76) Inventor: Locke White II, Radford, VA (US)

Correspondence Address: Schwartz Law Firm, P.C.;Suite 530, SouthPark Towers, 6100 Fairview Road, Charlotte, NC, 28210, US

(21) Appl. No.: 11/319,866

(22) Filed: Dec. 27, 2005

Related U.S. Application Data
(63) Continuation of application No. 10/289,004, filed on Nov. 6, 2002, now Pat. No. 6,979,379.
(60) Provisional application No. 60/662,867, filed on Mar. 17, 2005.

(51) Int. Cl. C09J 5/00

(52) U.S. Cl. 156/152

(57) ABSTRACT

A method for preserving a perishable product includes the step of placing the perishable product on a flexible sheet. Using a handheld applicator, a releasable contact adhesive is then applied to a first surface area of the sheet. The sheet is then folded around the product. A second surface area of the sheet is then pressed against the adhesive applied to the first surface area to temporarily seal the product inside the folded sheet, thereby preserving the product.

### TECHNICAL FIELD AND BACKGROUND OF INVENTION

This application relates to a method for preserving a perishable product. The invention is especially applicable to packaged food products which are purchased by a consumer, opened for use, and then re-closed to store remaining food product in the package for later use. In a second application, the invention is a method for preserving leftover food which is stored inside one or two flexible sheets of wrap or an open-top container. In each case, the invention offers a convenient and reliable way to store food and guard against premature spoiling and/or inadvertent spillage. In yet another application, the invention may be used to preserve any perishable non-food product subject to chemical reaction, degradation, or other transformation when exposed to air, water, or other outside elements. Other perishable non-food products may include, for example, paint brushes, paint, soil, grass seed, fertilizer, chemicals, cement, mortar, and the like.

A recent study by the University of Arizona estimates that U.S. households throw away $30 billion worth of spoiled food annually. This figure is especially staggering considering the fact that billions more are spent each year on consumer food wrap products and food packaging material designed to keep that same food from going bad. Unfortunately, the facts show that these products alone are just not getting the job done.

### SUMMARY OF INVENTION

Therefore, it is an object of the invention to provide a method for preserving perishable products which is both convenient and highly reliable.

It is another object of the invention to provide a method for preserving perishable products which requires little effort and expense.

It is another object of the invention to provide a method for preserving perishable products which utilizes a conventional glue stick or other handheld adhesive applicator.

It is another object of the invention to provide a method for preserving perishable products which utilizes a non-permanent or repositionable adhesive capable of adhering and readhering to any food package or container.

It is another object of the invention to provide a method for preserving perishable products which utilizes a pressure-sensitive, contact adhesive capable of adhering and readhering to slick surfaces, such as plastic kitchen containers, Teflon-coated pots and pans, kitchen food wraps, and plastic sandwich bags.

It is another object of the invention to provide a method for preserving perishable products which utilizes a highly aggressive adhesive which performs well in both hot and cold environments, such as inside a refrigerator and oven.

It is another object of the invention to provide a method for preserving perishable products which utilizes an adhesive which is water-soluble so that it easily washes off surfaces with soap and water in the sink or in the dishwasher.

It is another object of the invention to provide a method for preserving perishable products which utilizes a common, food-grade adhesive.

It is another object of the invention to provide a method for preserving other packaged items, such as fertilizer, grass seed, soil, or any other product prone to spillage when inadvertently dropped or tipped over.

These and other objects of the present invention are achieved in the preferred embodiments disclosed below by providing a method for preserving a perishable product contained in a sealed package. The package is adapted for being opened by a consumer to access the product and subsequently re-closed by the consumer for further storage of unused product remaining in the package. The method includes the step of, using a handheld applicator, applying a releasable contact adhesive to a first area of the package adjacent to an opening formed in the package by the consumer. A second area of the package is then pressed against the adhesive to temporarily re-close the opening, thereby preserving the unused product inside the package.

The term “perishable product” is used broadly herein to include any product which may spoil, decay, or become stale over a period of time; or which may dissolve, transform, or otherwise react when exposed to elements outside of its packaging, such as water, cold, or heat; or which may spill out of its packaging when inadvertently dropped or tipped over; or which may decline to a lower condition, quality or level when exposed to air, water, or any outside element.

According to another preferred embodiment of the invention, the method further includes the steps of reopening the package at the opening to access the unused product, and subsequently folding and readhering the package to re-close the opening without further application of the adhesive to the package.

According to another preferred embodiment of the invention, the step of applying the adhesive includes applying the adhesive in a continuous path extending along an entire length of the opening.

According to another preferred embodiment of the invention, the handheld applicator is an elongated stick container.

According to another preferred embodiment of the invention, and notwithstanding the performance of the adhesive, the method further includes placing the unused product contained in the re-closed package in a refrigerator at a temperature less than 50 degrees Fahrenheit.

According to another preferred embodiment of the invention, and notwithstanding the performance of the adhesive, the method includes placing the unused product contained in the re-closed package in a freezer at a temperature less than 32 degrees Fahrenheit.

According to another preferred embodiment of the invention, and notwithstanding the performance of the adhesive, the method includes placing the unused product contained in the re-closed package in an oven at a temperature greater than 100 degrees Fahrenheit.

Preferably, the adhesive is a food-grade adhesive. The term “food-grade adhesive” is defined by FDA specifications found in Title 21 of the Code of Federal Regulations, incorporated in its entirety herein by this reference. Specific examples of adhesive substances generally considered safe in and around food are provided in 21 C.F.R. §§175.105 and 175.125. Suitable adhesives could be sugar based, starch based, or silicone based, for example.

In another embodiment, the invention is an alternative method for preserving a perishable product. The method includes the steps of placing the perishable product on a flexible sheet; using a handheld applicator, applying a releasable contact adhesive to a first surface area of the sheet; folding the sheet around the product; and pressing a second surface area of the sheet against the adhesive applied to the first surface area to temporarily seal the product inside the folded sheet, thereby preserving the product.

According to this preferred embodiment of the invention, the method further includes the steps of unfolding the sheet to access the product, and subsequently resealing the product inside the sheet without an additional application of adhesive.

In yet another embodiment, the invention is a further alternative method for preserving a perishable product. This method includes the steps of placing the perishable product on a first flexible sheet; using a handheld applicator, applying a releasable contact adhesive to a surface area of the first sheet; covering the product with a second flexible sheet; and pressing a surface area of the second sheet against the adhesive applied to the surface area of the first sheet to temporarily seal the product inside and between the first and second sheets, thereby preserving the product.

According to this preferred embodiment of the invention, the method further includes the steps of removing at least one of the first and second sheets to uncover and access the product, and subsequently resealing the product inside and between the first and second sheets without an additional application of adhesive.

In yet another embodiment, the invention is a further alternative method for preserving a perishable product. This method includes the steps of placing the perishable product on a first flexible sheet; using a handheld applicator, applying a releasable contact adhesive to a surface area of a second flexible sheet; covering the product with the second sheet of flexible sheet; and pressing a surface area of the first sheet against the adhesive applied to the surface area of the second sheet to temporarily seal the product inside and between the first and second sheets, thereby preserving the product.

According to this preferred embodiment of the invention, the method further includes the steps of removing at least one of the first and second sheets to uncover and access the product, and subsequently resealing the product inside and between the first and second sheets without an additional application of adhesive.

In yet another embodiment, the invention is a method for preserving a perishable product located in an open container. This method includes the steps of using a handheld applicator, applying a releasable contact adhesive to at least one of a flexible sheet and an outer surface of the container; and covering an open top of the container with the sheet such that the sheet and adhesive cooperate to releasably seal the container, thereby preserving the product stored in the container.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a view of an opened food package, and demonstrating application of the contact adhesive used for temporarily closing the package according to one embodiment of the present method;

FIG. 2 is a view of the sealed package after application of the present method;

FIG. 3 is a view of an open-top container used for storing leftover food, and demonstrating application of the adhesive and sheet to the container to temporarily close the open top according to a second preferred embodiment of the present method;

FIG. 4 is a view of the covered container after application of the present method;

FIG. 5 is a view of the glue stick mounted on the door of a standard refrigerator;

FIG. 5A is an enlarged view of the glue stick and holder shown in the bubble of FIG. 5;

FIG. 6 is an elevational view of a glue stick according to a second preferred embodiment of the invention;

FIG. 7 is an elevational view of a glue stick and holder according to a third preferred embodiment of the invention;

FIG. 8 is view showing a perishable food item placed on a flexible sheet, and demonstrating the application of adhesive to selected areas of the sheet;

FIGS. 9A and 9B are sequential views showing the flexible sheet being folded around the food product;

FIGS. 10A and 10B are sequential views demonstrating application of the present method according to another preferred embodiment; and

FIG. 11 is a view demonstrating application of the present method according to yet another preferred embodiment.

### DESCRIPTION OF THE PREFERRED EMBODIMENT AND BEST MODE

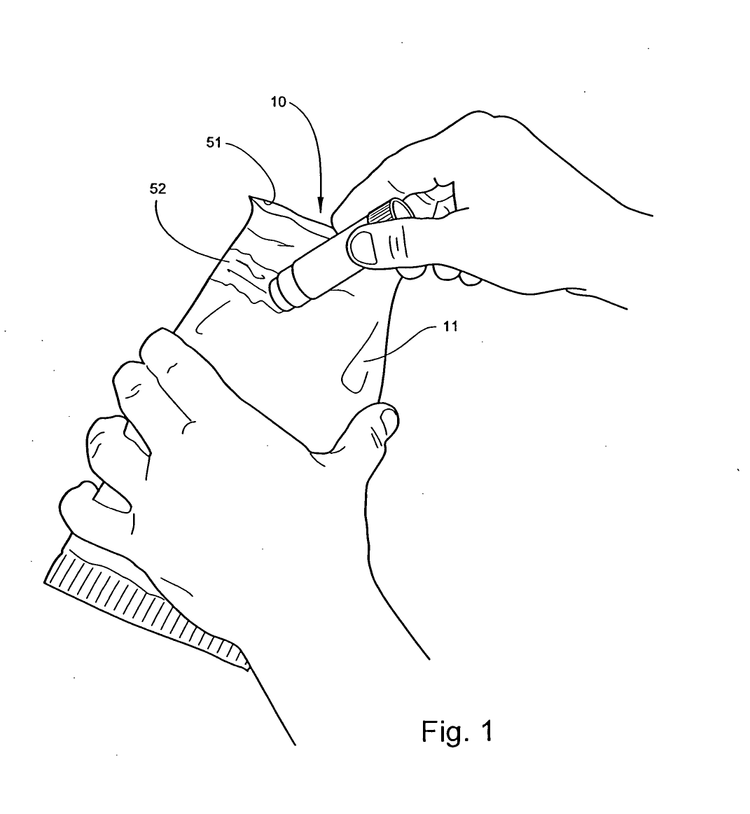

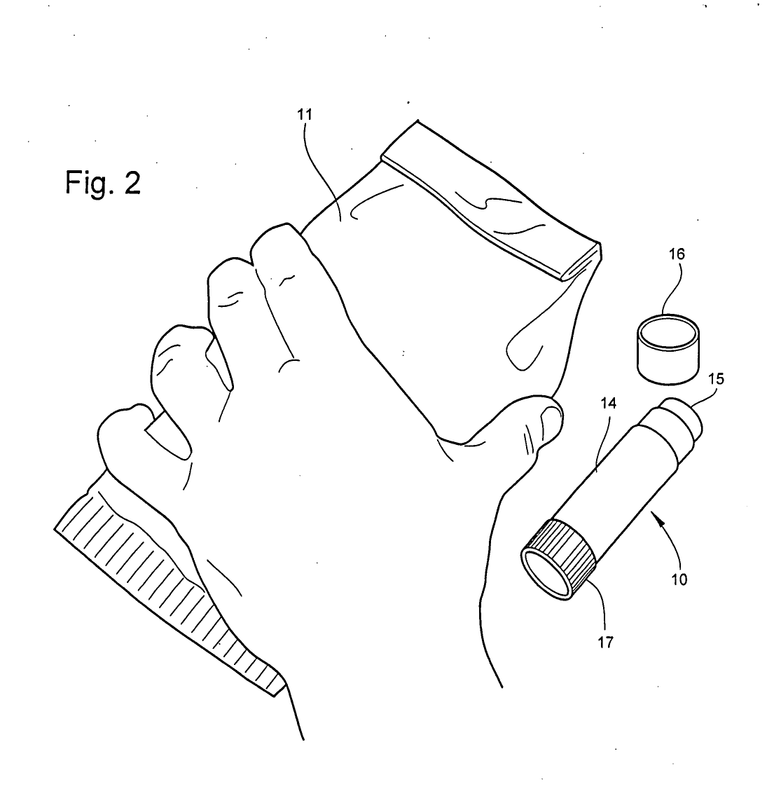

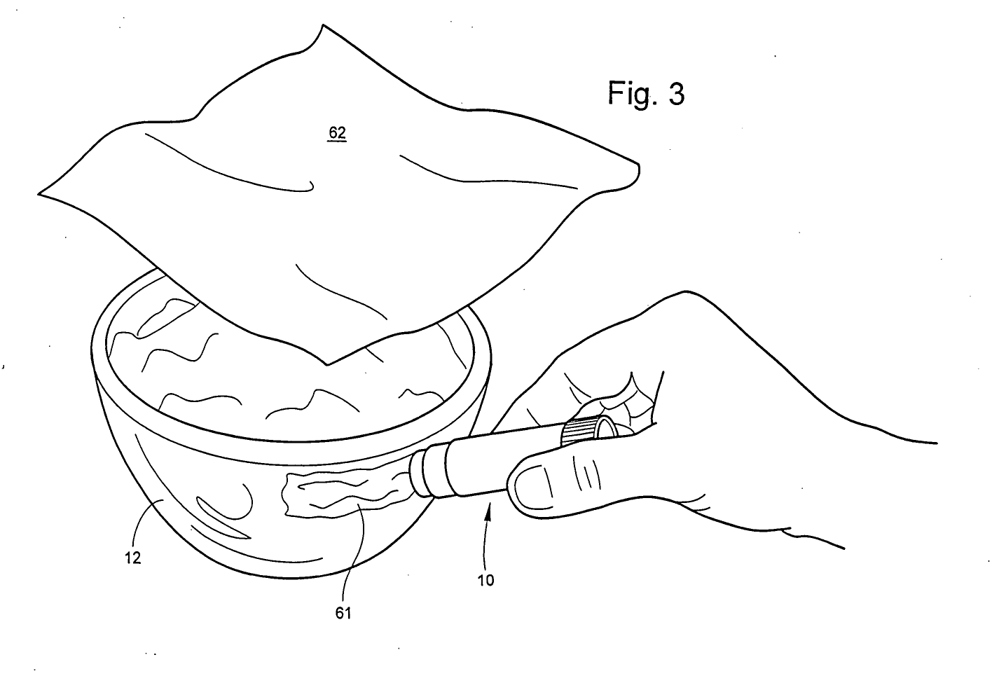

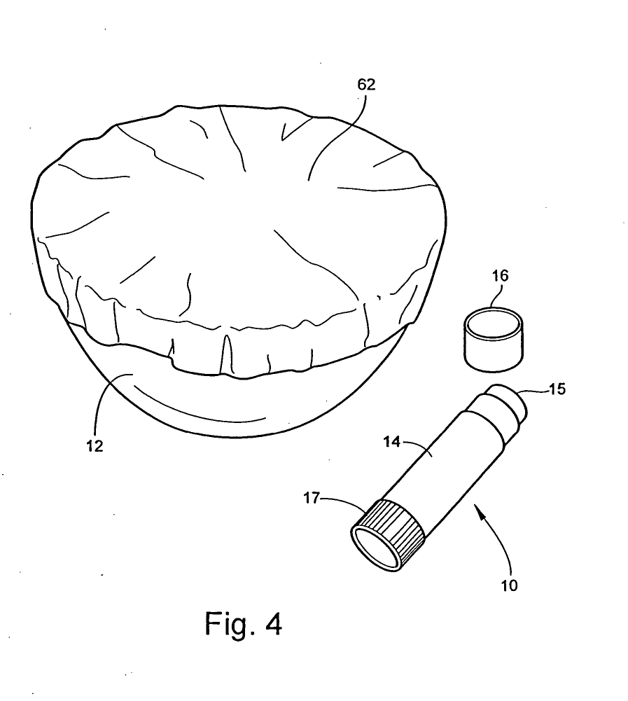

Referring now specifically to the drawings, a handheld glue stick adapted for use in a method according to the present invention is illustrated in FIG. 1, and shown generally at reference numeral 10. In one embodiment, demonstrated in FIGS. 1 and 2, the present method is intended to preserve a perishable food product which is contained in a sealed package 11 when purchased, and which is later opened by a consumer to access the food product and then re-closed for further storage of unused product remaining in the package 11. According to the present method, the remaining food product is preserved inside the package 11 until used again by the consumer. The method is especially applicable to food products, such as potato chips, crackers, box cereal, sugar, flour, bread, and other perishable items commonly purchased at retail grocery stores. In an alternative embodiment, demonstrated in FIGS. 3 and 4, the present method preserves leftover food stored in an open-top container 12. In each case, the method utilizes the glue stick 10, or any other suitable handheld adhesive applicator. The glue stick 10 has an elongated cylindrical shell 14 for containing the adhesive 15, a removable cap 16 covering an open end of the shell 14, and a twisting base 17 to cause extension and retraction of the adhesive 15. Examples of glue sticks applicable for use in the present method include those described in U.S. Pat. Nos. 4,684,685; 5,331,023; 5,409,977; and 6,136,119. The complete disclosure of each of these patents is incorporated herein by reference.

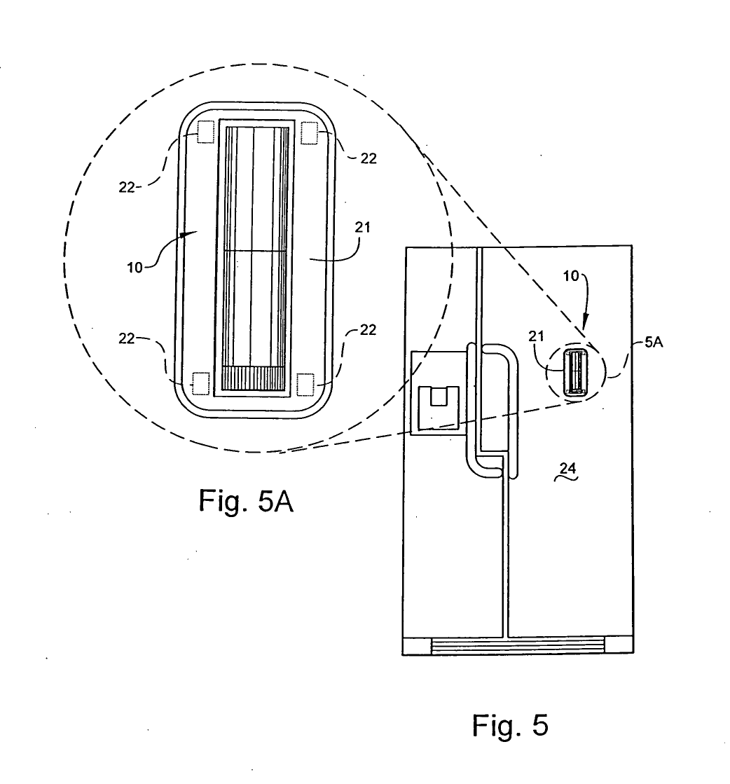

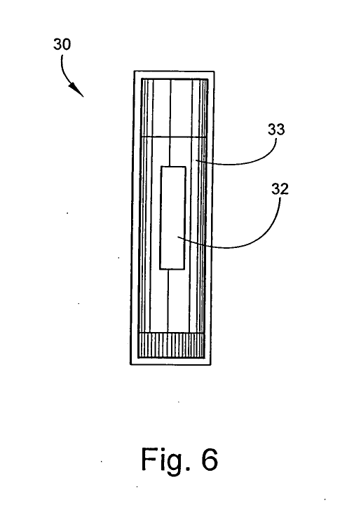

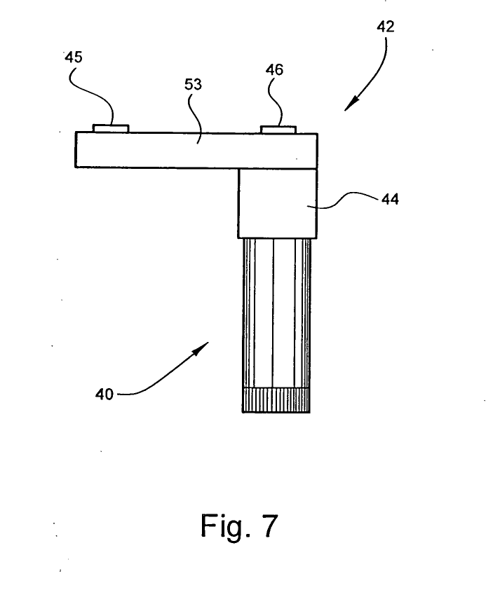

For added convenience, the glue stick 10 is preferably stored in the kitchen area. In the embodiment of FIGS. 5 and 5A, the glue stick 10 is removably mounted in a slightly recessed well formed in a holder 21. The holder 21 has magnets 22 located on its backside and at each corner to magnetically attach the holder 21 to any metal surface, such as a refrigerator door 24. In an alternative embodiment shown in FIG. 6, the glue stick 30 includes a magnet 32 molded with its outer shell 33 to attach the glue stick 30 directly to the metal surface. In yet another embodiment shown in FIG. 7, the glue stick 40 is carried by a holder 42 having an adhesive base 43, and a cylindrical receiver 44 attached to the base 43 and adapted to receive an open end of the glue stick 40. The receiver 44 extends perpendicular to the base 43, and is of a size and shape corresponding to that the of the original cap covering the open end of the glue stick 40. The adhesive base 43 has peel-and-stick pads 45 and 46 which allow the glue stick 40 to be mounted in an inverted position under overhead kitchen cabinets, pantry shelves, and the like.

Referring again to FIGS. 1-4, the present method is applicable for re-closing an opened food package 11 in order to preserve the unused contents of the package 11 for later use. After purchasing the food product, the consumer generally forms an opening 51 in the package 11 by pulling apart the walls of the package 11 at one closed end, or by separating the walls at the closed end along a preformed tear line. The resulting opening 51 typically extends entirely, or at least partially, along the torn end edge of the package 11. In any case, the opening 51 is sufficiently large to conveniently remove the contents of the package 11 for use. To re-close the package 11 according to the present method, the consumer uses the glue stick 10 to apply a thin layer of readhering, pressure-sensitive, contact adhesive 52 to an area of the package 11 adjacent the opening 51. Preferably, the adhesive 52 is applied in a continuous path which extends along the entire length of the opening 51. After applying the adhesive 52, the package 11 is folded at the opening 51 such that a second area of the package 11 is pressed against the adhesive 52 to re-close and seal the package 11. When the consumer desires to use the remaining contents of the package 11, the package 11 is reopened at the previously formed opening 51 by separating the adhering areas of the package 11. Additional unused food product is further preserved by subsequently readhering the first and second areas of the package 11 to re-close the opening 51. The areas are preferably readhered without further application of the adhesive 52 to the package 11.

A second application of the present method is demonstrated in FIGS. 3 and 4. In this application, leftover food is placed in the open-top container 12 for storage. The glue stick 10 is then used to apply a thin layer of pressure-sensitive, contact adhesive 61 to an outside surface of the container 12. Preferably, the adhesive 61 is applied in a continuous path extending along the entire outside margin of the container 12 adjacent the open top. After applying the adhesive 61, a flexible sheet of thermoplastic, paper, or aluminum wrap 62 is placed over the open top of the container 12, and is pressed against the adhesive 61 to seal the container 12 and preserve the food for subsequent use. The covered container 12 may be placed in the refrigerator or freezer at temperatures less than 50 degrees Fahrenheit and 32 degrees Fahrenheit, respectively, or in an oven at temperatures in excess of 100 degrees Fahrenheit. Preferably, the high and low temperatures do not adversely affect the performance of the adhesive 61. The adhesive 61 is water-soluble for easy cleaning, and is readherable so that the container 12 can be uncovered and later recovered using the same wrap 62 and without additional application of adhesive 61 to the container 12.

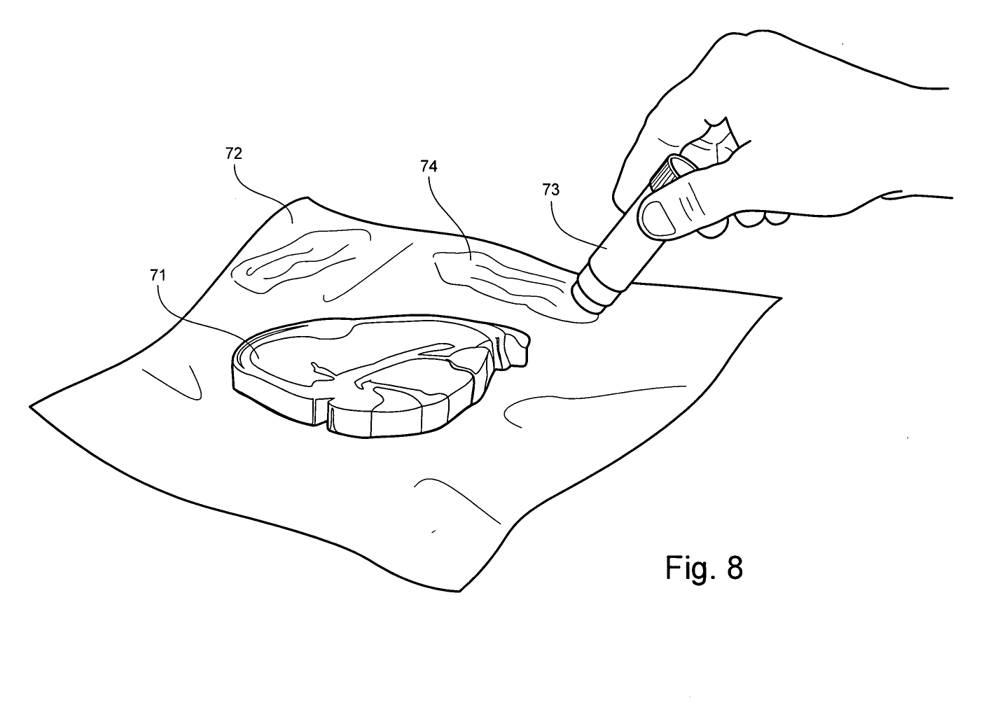

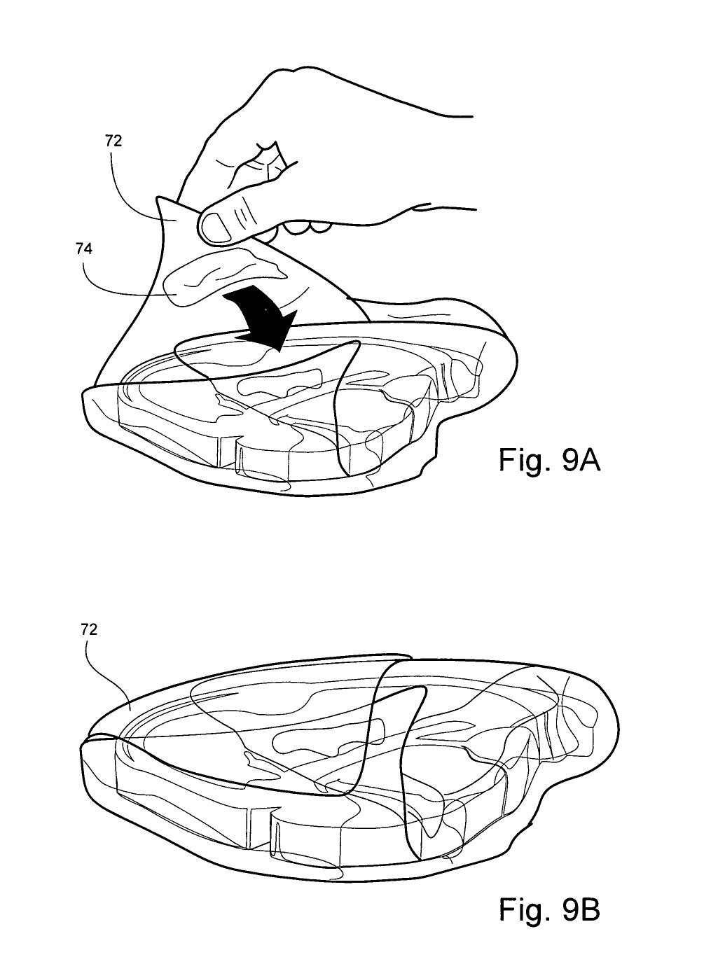

FIGS. 8, 9A, and 9B demonstrate application of the present method according to an alternative preferred embodiment. According to this embodiment, a perishable product 71 (such as a food product) is placed on a sheet of flexible sheet 72. The sheet 72 may comprise any flexible sheet material, such as a thin thermoplastic, thicker wax paper, other paper, aluminum foil, and the like. As shown in FIG. 8, using the hand-held applicator 73, a releasable food-grade adhesive 74 such as previously described is then applied to selected areas of the sheet 72. The sheet 72 is then folded around the food product 71, as demonstrated in FIGS. 9A and 9B. The wrapped food product 71 may then be stored in a refrigerator or freezer, and may also be heated directly in an oven. To access the food product 71, the folded sheet 72 is simply unfolded and the desired portion of food product 71 separated and removed. Any remaining food product 71 can then be re-wrapped without further application of adhesive 74.

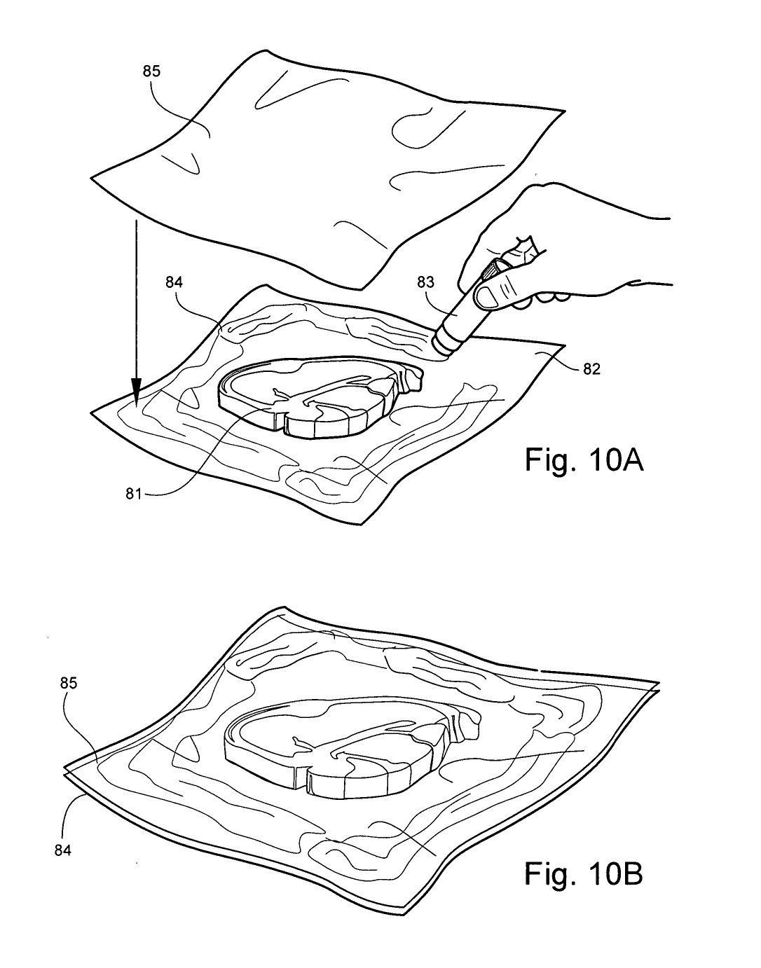

FIGS. 10A and 10B demonstrate another preferred embodiment of the present invention. In this embodiment, a perishable product 81 is placed on a flexible sheet 82, as described above. Using the hand-held applicator 83, a releasable food-grade adhesive 84 is then applied to selected areas of the sheet 82. A second flexible sheet 85 is then placed over the perishable product 81 and pressed against the first sheet 82 in areas of the adhesive 84, thereby temporarily sealing the product 81 inside and between the first and second sheets 82, 85. Alternatively, the adhesive 84 may first be applied to the second sheet 85. To access the product 81, the first or second sheet 82, 85 is simply peeled back to expose the product 81. A desired portion of the product 81 is then separated and removed. Any remaining product 81 can then be re-covered between the sheets 82, 85 without further application of adhesive 84. According to this embodiment, multiple products may be placed spaced-apart locations on the bottom sheet and the adhesive applied to the sheet between and around the products. The top sheet is then applied over the products and bottom sheet and pressed against the bottom sheet in areas of the adhesive. The result is a storage system comprising multiple, divided and substantially air-sealed compartments for separately storing respective products.

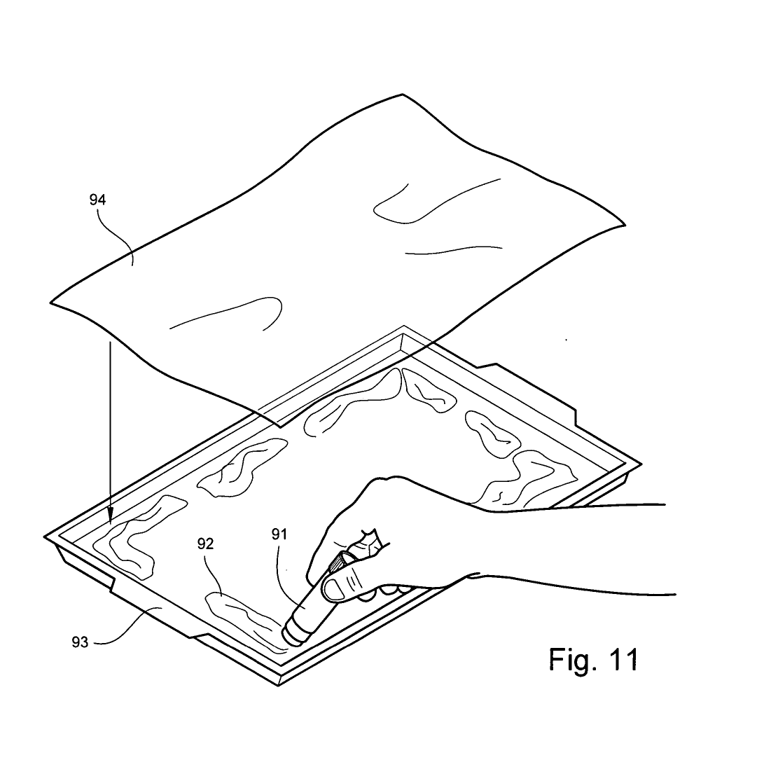

A still further application of the present method is demonstrated in FIG. 11. In this embodiment, using the hand-held applicator 91, a releasable food-grade adhesive 92 is applied to areas of a standard baking sheet 93, and a flexible sheet 94 (e.g., wax paper) then laid over the baking sheet 93 and pressed against the adhesive 92. Alternatively, the adhesive 92 may first be applied to the wax paper 94.

A method for preserving a perishable food product is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A method for preserving a perishable product, said method comprising the steps of:
(a) placing the perishable product on a flexible sheet;
(b) using a handheld applicator, applying a releasable contact adhesive to a first surface area of the sheet;
(c) folding the sheet around the product; and
(d) pressing a second surface area of the sheet against the adhesive applied to the first surface area to temporarily seal the product inside the folded sheet, thereby preserving the product.

2. A method for preserving a perishable product according to claim 1, and further comprising the steps of unfolding the sheet to access the product, and subsequently resealing the product inside the sheet without an additional application of adhesive.

3. A method for preserving a perishable product according to claim 1, wherein the handheld applicator comprises an elongated cylindrical housing with an opening for dispensing the adhesive.

4. A method for preserving a perishable product according to claim 3, and comprising removably attaching the hand-held applicator to a metallic surface when the applicator is not in use.

5. A method for preserving a perishable product, said method comprising the steps of:
(a) placing the perishable product on a first flexible sheet;
(b) using a handheld applicator, applying a releasable contact adhesive to a surface area of the first sheet;
(c) covering the product with a second flexible sheet; and
(d) pressing a surface area of the second sheet against the adhesive applied to the surface area of the first sheet to temporarily seal the product inside and between the first and second sheets, thereby preserving the product.

6. A method for preserving a perishable product according to claim 5, and further comprising the steps of removing at least one of the first and second sheets to uncover and access the product, and subsequently resealing the product inside and between the first and second sheets without an additional application of adhesive.

7. A method for preserving a perishable product according to claim 5, wherein the handheld applicator comprises an elongated cylindrical housing with an opening for dispensing the adhesive.

8. A method for preserving a perishable product according to claim 7, and comprising removably attaching the hand-held applicator to a metallic surface when the applicator is not in use.

9. A method for preserving a perishable product, said method comprising the steps of:
(a) placing the perishable product on a first flexible sheet;
(b) using a handheld applicator, applying a releasable contact adhesive to a surface area of a second flexible sheet;
(c) covering the product with the second flexible sheet; and
(d) pressing a surface area of the first sheet against the adhesive applied to the surface area of the second sheet to temporarily seal the product inside and between the first and second sheets, thereby preserving the product.

10. A method for preserving a perishable product according to claim 9, and further comprising the steps of removing at least one of the first and second sheets to uncover and access the product, and subsequently resealing the product inside and between the first and second sheets without an additional application of adhesive.

11. A method for preserving a perishable product according to claim 9, wherein the handheld applicator comprises an elongated cylindrical housing with an opening for dispensing the adhesive.

12. A method for preserving a perishable product according to claim 11, and comprising removably attaching the hand-held applicator to a metallic surface when the applicator is not in use.

13. A method for preserving a perishable product located in an open container, said method comprising the steps of:
(a) using a handheld applicator, applying a releasable contact adhesive to at least one of a flexible sheet and an outer surface of the container; and
(b) covering an open top of the container with the sheet such that the sheet and adhesive cooperate to releasably seal the container, thereby preserving the product stored in the container.

14. A method for preserving a perishable product according to claim 13, and further comprising the steps of uncovering the sheet at the open top of the container to access the product, and subsequently readhering the sheet to the container to re-close the open top without further application of adhesive to the container or sheet.

15. A method for preserving a perishable product according to claim 13, wherein the step of applying the adhesive comprises applying the adhesive in a substantially continuous path extending along an outside rim of the container adjacent the open top.

16. A method for preserving a perishable product according to claim 13, wherein the handheld applicator comprises an elongated cylindrical housing with an opening for dispensing the adhesive.

17. A method for preserving a perishable product according to claim 16, and comprising removably attaching the hand-held applicator to a metallic surface when the applicator is not in use.

18. A method for preserving a perishable product according to claim 16, and comprising removably attaching the hand-held applicator to a refrigerator when the applicator is not in use.
